(19) United States
(12) Patent Application Publication
(10) Pub. No.: US 2007/0006652 A1
(43) Pub. Date: Jan. 11, 2007

(54) Load measuring sensor and method

(75) Inventors: James P. Weldon JR., North Hampton, NH (US); Marthinus C. van Schoor, Medford, MA (US); Attila Lengyel, Somerville, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Abnaki Systems, Inc., North Hampton, NH (US)

(21) Appl. No.: 11/343,353

(22) Filed: Jan. 31, 2006

Related U.S. Application Data
(60) Provisional application No. 60/697,506, filed on Jul. 6, 2005.

(51) Int. Cl. G01H 13/00; G01N 29/04

(52) U.S. Cl. 73/579

(57) ABSTRACT

Systems and methods for measuring a load in a structural element include placing at least one actuator and sensor on the structural element. The actuator is capable of exciting a wave of a predetermined frequency in the structural element and the sensor is capable of sensing the wave excited in the structural element. A computer control unit is applied to operate the actuator so as to excite a wave in the structural member in at least a first frequency, and to operate the sensor so as to measure at least one of a change in a resonance frequency in the structural element as a result of a change in loading on the structural member and a change in phase angle in the wave sensed by the sensor as a result of a change in loading on the structural member.

### RELATED APPLICATIONS

This patent application claims priority to Provisional U.S. Patent Application No. 60/697,506, filed on Jul. 6, 2005 and entitled “Load Measuring Sensor and Method.” The priority application is hereby incorporated by reference in its entirety herein.

### FIELD OF THE INVENTION

The present invention relates to a system for sensing the axial load in a structure or structural component by exciting higher order bending modes in that structure and measuring shifts in the resonant frequencies and phases of selected higher order modes that are caused by changes in gravitational mass-loading of the structure.

### BACKGROUND

Accurate weight and balance information is crucially important for the safe and efficient operation of aircraft, many ground and sea vehicles (trucks, busses, trains, ocean freighters), and certain static load-bearing structures such as bridges and containment vessels. Progress developing automatic on-board weight and balance systems has been impeded by a broad range of deficiencies in the prior art sensing technology which limit or preclude on-board automatic measurement of vehicle weight-related data.

Operationally suitable load sensing technology for determining aircraft weight-related data is a particular need. A number of fatal military and commercial aircraft accidents have occurred despite the application of presently existing Federal Aviation Administration (FAA) approved operational practices for estimating aircraft weight and balance. Currently, all commercial, military and private aircraft operators employ variations of this estimation technique for calculating aircraft weight and balance. These procedures generally employ “average” weight values for passengers and baggage and accept “labeled” weight values for cargo. The process is a labor-intensive system of manual counting and manual data entry and manipulation that is prone to statistical and human error. The results create significant operational inefficiencies in the form of increased fuel and labor costs and lost productivity. Errors in the procedure affect safety of flight by invalidating such critical weight and balance information as maximum takeoff weight, aircraft controllability, takeoff trim settings, required takeoff speeds, required runway distances for takeoff, flap settings for takeoff and landing, required speeds and distances to reject a takeoff, maximum altitude and speed capabilities, and landing speed, altitude and runway length requirements.

Operators of ground transportation vehicles such as trucks, busses and trains are also required by federal regulation to operate their vehicles within certain weight limits, based on vehicle design and road or track weight-bearing capabilities. Train operators value accurate weight and balance information so as to protect track and vehicle integrity by ensuring that axle loads are not too high and that wagonloads are not unbalanced. Truck operators—including long-haul commercial bulk goods carriers and “Haul Truck” mining operators, and others—are concerned with safety, legal compliance, and real-time measurement and management of vehicle productivity.

There are two broad categories of automatic systems which measure air and ground vehicle weight and weight-related data directly: “Off-board” systems and “On-board” systems.

Off-board vehicle weighing systems generally utilize conventional load cell and scale technology and provide accurate gross weight and weight distribution measurements. These off-board systems, however, create bottlenecks and inefficiencies in vehicular flow patterns, constraining the flexibility of operators of air and ground vehicles (especially in remote operating areas) and reducing productivity. Daily operational scale weighing of aircraft is considered to be especially inefficient, and there are very few weighing scale systems in operational use at airports for military, commercial or private flight operations. In the commercial ground transportation communities, operational practices vary widely among, with external scale weighing employed generally by state regulatory and law enforcement agencies.

On-board aircraft weighing systems typically measure landing gear sheer or bending stress, or changes in strut nitrogen or hydraulic pressure. Prior attempts at developing on-board vehicle weight and balance systems have generally been impeded by deficiencies with on-board sensor technology. An on-board weight and balance sensor must produce consistently accurate measurements of meaningful, load-related physical parameters. An ideal sensor would be:
Physically robust and able to survive and function in the vehicle's harsh operational environment (very high mean-time-between-failure);
Contribute little or no electromagnetic interference (EMI), especially in aerospace applications;
Insensitive to temperature;
Scalable in terms of physical size and be implementable in critical structural areas without interfering in structural performance;
Suitable for employment in sufficient numbers so as to enable the instrumentation of a plurality of likely structural load paths;
Implementable using various mounting and attachment configurations—such as bonding, bolt-on, and clamp-on arrangements; and
Relatively inexpensive.

Prior art “on-board” weight and balance patents typically employ strain gages, linear displacement sensors, inductive proximity sensors, or pressure transducers as the active sensing elements. These devices generally fail to meet the operational needs of aircraft and ground vehicle operators, including requirements for measurement accuracy, measurement repeatability, robustness, maintainability, affordability, sensor size, and ease of sensor implementation in individual vehicle applications.

Strain gages exhibit limited utility as measurement devices in harsh operational environments such as aircraft landing gear and truck axles because of a number of fundamental problems. One disadvantage with strain gages is that they are generally bonded to a structural surface. The bonding agent acts as an intermediate buffer between the strain gage and the structure, and adds a degree of separation from the structure, so that the gage effectively measures the strain of the bonding agent, as opposed to directly measuring the strain of the substrate or structural material. Additionally, the act of bonding strain gages to a structural substrate is not a uniform process with uniform bonding agent thicknesses, hence each gage effectively exhibits a unique response function. This means that the failure of a plurality of strain gages creates the expensive requirement to recalibrate the system, as it is highly unlikely that the electrical output voltage produced by the replacement gages will exactly duplicate the output generated by the original transducers.

A further disadvantage with strain gages is that active strain-sensitive elements within the sensor are very fine wires which are susceptible to damage from handling during shipment or storage, during the installation of the transducer, and from shock loads and impacts normally imposed on aircraft landing gears and vehicle axles. Replacing broken strain gages reintroduces the problems associated with non-uniform bonding and variable gage response to strain, exposing the operator to the expense of system recalibration.

Still further, the resistance in the strain sensitive elements tends to change with the surrounding temperature (thermal drift), thereby generating erroneous electrical output signals unless a system is provided to compensate for changes in temperature. Typically, temperature compensation systems can be sensitive to other, non-temperature related inputs, and sophisticated temperature compensating components are frequently required.

Yet another disadvantage of strain gages relates to their low output voltage and vulnerability to contamination. Strain gage transducers generally produce very small electrical output voltage, usually on the order of a few millivolts, while relying on significant internal changes in electrical resistance to affect the strain measurement. The accuracy of the strain gage system may therefore be severely reduced by any low impedance electrical leakage caused by the introduction of moisture or other contaminants within the transducer or in the wiring to the transducer.

A further disadvantage of strain gages is trouble with localization. Individual strain gages are sensitive only to highly localized changes in strain. Smaller numbers of strain gages therefore often produce poor measurement repeatability, as individual strain gages are not sensitive to variations in structural load path.

Another common sensor operates on the principle of inductance. Inductance and linear displacement sensors suffer from a number of inherent disadvantages that make them unsuitable for a majority of aircraft and ground vehicle weight and balance applications.

Inductance sensors, like strain gauges, suffer from problems relating to localization. Inductance sensors and linear displacement sensors produce an output voltage based on the displacement of their mechanical attachment points, with the assumption being that displacement is the result of strain. Inductance and linear displacement sensors, therefore, do not capture information that results from variations in structural load paths.

Inductance sensors encounter further problems due to their mounting. Inductance and linear displacement sensors suffer mounting disadvantages, as sensor design requires at least two co-located secure mechanical mounting points per sensor. This requirement limits the number of structural components that are suitable for sensor implementation, and limits the locations within a vehicle structure that are suitable for sensor employment. Mounting structure also influences sensor measurements, as the mounting structure will not be 100% representative of the intended structural application.

Inductance sensors also suffer from size and bulk disadvantages. Sensor size and bulk become limiting factors in the restricted confines of aircraft and ground vehicle structural support systems. Inductance sensors are frequently too large for many vehicles applications.

A still further sensor available in the art is the embedded load cell. It has been proposed to employ conventional load cells, mounted contiguously along a structural load path within a structure, in order to directly sense load. The act of incorporating load cells contiguously into a structure raises safety, structural integrity, retrofit, and maintainability-replacement concerns. Conventional load cells typically measure a deflection of the structure using strain gages—therefore, an “integral load cell” would not be structurally sound, as it would create additional degrees of freedom and possible sources of failure into the structure. Embedded load cells are completely unsuitable for aircraft applications. Other disadvantages include sensor maintenance and replacement problems.

Several authors have proposed aircraft and ground vehicle weight and balance systems that employ pressure transducers to measure oleo-strut or hydraulic strut pressures (see, e.g., patent nos. U.S. Pat. No. 6,237,407; U.S. Pat. No. 5,548,517; U.S. Pat. No. 5,214,586; and U.S. Pat. No. 5,521,827 for the use of pressure in oleo struts, and U.S. Pat. No. 5,258,582 for the use of pressure in hydraulic cylinders). Measuring nitrogen pressure in landing gear struts produces poor measurement repeatability due to stiction (a combination of binding and friction) in the landing gear struts. The prior art attempts to compensate for stiction by employing a system of pumps and pneumatic lines that introduce fluid or gas pressure into oleo-strut, then release that pressure and average the pre- and post-pumping measurements.

Pressure transducer measurements of strut pressures suffer from inherent stiction, and hence inaccuracy, problems. Systems employing such measurements often attempt to compensate for wide error bandwidth in the measurement by taking two or more measurements and averaging the results. Pressure based systems that must compensate for stiction forces by introducing pumps and pneumatic lines into aircraft or other vehicles increase mechanical complexity and add weight to the vehicle.

It is therefore a goal of the present invention to provide a system that alleviates at least some of the deficiencies of strain gage, inductance, linear displacement and pressure type transducers and sensors for purposes of determining structural load. The present invention, by measuring changes in resonant frequency and phase of certain higher-order bending modes in structural components, is capable of accurately measuring the loads on such structural components as aircraft landing gear members and truck axles.

### SUMMARY

The present invention relates to a system for sensing the axial load in a structure or structural component by exciting one or more bending modes in that structure and then sensing the changes in the associated resonant frequencies or phases that are caused by changes in loading of the structure.

A standing wave is generated in a subject structural component by one or more actuators, which can be placed spatially on the structural component in such a way as to optimize the excitation of the intended resonant modes. The resulting standing wave is sensed by one or more receivers, or sensors, which can be attached spatially along the structural element in such a way so as to filter out unwanted modes and minimize unwanted standing wave activity, thus increasing sensitivity to the resonant modes of interest. Changes in loading on the subject structure or subject structural component change the exact nature of the resonant modes of interest. These changes are manifested by shifts in the resonant frequencies of the modes of interest and by certain phase shifts associated with these resonant frequency shifts. The resonance load sensor of the invention can measure axial loading, and hence gravitational mass loading, by measuring these changes in the structure's resonant response to excitation in certain bending modes.

A system and method of the invention can be used to accurately determine changes in the axial loading of a structural element. This methodology can be insensitive to the non-gravitational mass loading of the structural element. When a plurality of the current invention is applied to a complex structure, e.g. an aircraft or ground vehicle such as a truck or train, and properly integrated into a total load sensing system, the systems and methods disclosed herein can serve as the primary sensory component for a highly accurate, automatic, on-board vehicular weight and balance system. The systems and methods of the present invention can also be used in non-vehicular structures such as containment vessels or buildings to measure gravitational loading of structural elements.

While not wishing to be held to one or more of the following particular objectives of the invention apart from any claims presently appended or ultimately provided, preferred embodiments within the scope of the invention will address one or more of the following objects:

It is one objective of the present invention to provide a Resonance Sensor that eclipses the performance of all prior art sensors made for the purpose of measuring axial load in a structure or structural component by measuring how changes in axial load affect the dynamical behavior of the structure. For the first time, structural load is determined by an accurate measurement of changes in the structure's dynamic response to load. This technique alleviates the multitude of problems found in prior art load sensors, enabling operators to glean real time information from a broad area of structure using small, robust, inexpensive, easily adapted actuator and sensing components and a dynamic process that eliminates the thermal and electronic drift found in the prior art.

It is a further objective of the present invention to provide a Resonance Sensor system that consistently and accurately measures the dynamic behavior of a structure as a result of changes in that structure's axial loading. This technology is based on the principle that a structural beam or column exhibits certain natural frequencies of vibration and associated modes of deformation, and that these natural or resonant frequencies and the associated phases change when the structure is loaded.

Another objective of the present invention is to provide a Resonance Sensor assembly that produces a repeatable, high level output signal proportional to the load carried by the member being monitored and over a wide variation in such load.

A further objective of the present invention is to provide a Resonance Sensor assembly that is capable of accurately measuring very small changes in axial load.

It is a further objective of the present invention to directly measure changes in a structure or structural component that results from gravity loading. In contrast to the strain gage, which measures its own changes in resistivity as strain is transferred through layers of bonding materials, or the inductance sensor, which generates a signal based on its own internal displacements, the Resonance Sensor directly measures changes in a structure's fundamental characteristics, its resonance response, caused by changes in applied axial load.

Yet another objective of the present invention is to provide a Resonance Sensor assembly that is rugged enough to withstand the harsh environments and shock loads associated with aircraft landing gears and truck axles. This ruggedness is achieved by the use of piezoelectric, magneto-restrictive and fiber optic actuators and strain sensors.

It is a further objective of the present invention to provide a robust Resonance Sensor that exhibits a very high mean-time-between-failure (MBTF). This invention is capable of consistent and accurate measurement in harsh operational environments such as on aircraft landing gear and truck axles, e.g. This consistent, high quality measurement performance is made possible by the robust nature of the piezo and magnetostrictive materials employed by the current invention in the actuation and sensing of vibrations in structural media. In contrast, the fragile wires used as primary sensing elements in the strain gage are susceptible to damage from handling during shipment, storage and during installation, and to failure from the shock loads and impacts normally imposed on aircraft landing gear and vehicle axles. Similarly, the measurement accuracy and resolution of inductance sensors diminish when the inductance sensor mechanism suffers shock damage.

It is a further objective of the present invention to provide a Resonance Sensor that uses a dynamic signal that measures the relationship between amplitudes at various frequencies of a plurality of elements, including the ratios of a plurality of sensor signal amplitudes to actuator signal amplitudes at these various frequencies. In contrast, the strain gage and inductance sensor prior art employ static signals to generate measurements of the absolute amplitude of an individual sensor's response to strain. Because the Resonance Sensor measures a ratio-ed dynamic signal, rather than an absolute static signal, it is less sensitive to arbitrary signal variations often caused by noise, temperature, stiction, and friction, amongst other things. In using this invention, the absolute value of the amplitude is not critical, only the frequency at which a ratio-ed maximum occurs while data is being taken.

It is a further object of the present invention to minimize thermal drift as a measurement concern. The present invention is sensitive to changes in a structural component's resonant frequency caused by changes in that structural component's axial loading. Hence, the present invention will be insensitive to overall thermal changes in a structure as long as those thermal changes do not create axial loads. For instance, if a beam is clamped between two points, and the clamps and all material that supports the clamps, are affected equally by thermal changes, there will be no thermally-induced axial load in the subject structural component. Under certain other conditions, however, thermal changes may lead to changes in axial loading that are not associated with changes in gravitational mass loading. For instance, if a beam that is clamped between two points is affected by a thermal change that does not affect the clamps, the beam will respond to the thermal loading by expanding or contracting. In this case the clamps will act to constrain the motion of the beam, and in so doing induce an axial load. If, however, the clamping mechanisms and the beam experience the same thermally induced rates of change, there will be no thermally induced change in the beam's axial loading, and the present invention will be insensitive to thermal changes.

It is another objective of the present invention to provide a Resonance Sensor that does not rely on an absolute DC signal, and instead measures a rationed AC signal, making the sensor system measurement performance much less susceptible to variations in output voltage. A Resonance Sensor is also less susceptible to contamination and reduced performance caused by shorting created by moisture, or other means, either within the transducer or in the wiring to the transducer. Strain gage type transducers combine significant source resistance with a very small electrical output voltage. Any electrical leakage either within the transducer or in the wiring to the transducer may significantly reduce the accuracy of the strain gage system. In using this invention, the absolute value of the amplitude is not critical, only the frequency at which a ratio-ed maximum occurs while data is being taken. The system measures the shift in resonant frequency by monitoring the ratio of the sensor (or receiver) output signal to the actuator (or input) signal.

It is another objective of the present invention to capture accurate load information for a structural component in the presence of changes in structural load path within that structural component. By virtue of the nature of wave propagation in media, and the proper placement of actuators and receivers, the present invention senses component response to load by measuring changes in the dynamic characteristics of the material in the path length of the invention's induced signal. Hence, the present invention acts to capture component load information in the path length of the invention's induced signal rather than sensing changes at a particular point in the structure. In contrast, the strain gage and inductance sensor prior art measure strain only at the point where the sensor is bonded or bolted.

Another objective of the present invention is to provide a Resonance Sensor assembly that can be mounted directly to the structural member in which the load being carried, thereby directly measuring the dynamic deformation of the structural member under load. The Resonance Sensor system is capable of being mounted to a structure by a variety of mechanisms—such as clamps, bolts and bonding—for attaching the actuating and receiving elements to the subject structure.

It is also an objective of the present invention to provide a Resonance Sensor assembly which does not contribute to or detract from the load carried by the member being monitored, nor impart any significant preload to the attachment points of the actuation or sensing elements or to the member being measured thereby preventing any unpredictable distortion of the loaded member or the attachment points.

It is a further objective of the present invention to provide a Resonance Sensor system that is substantially less sensitive than a strain gage to the detrimental effects of the bonding agent. In contrast to the strain gage, no significant damping, attenuation or other degradation of the Resonance Sensor signal occurs due to small variations in bonding agent thickness. Small variations in bonding agent thickness have a negligible effect on the transfer of the vibration between the piezo or magneto-resistive sensing or actuation elements and the structure.

It is a further objective of the present invention to provide a Resonance Sensor system that can be expanded into a network with a plurality of actuators and receivers so as to capture broader structural information, minimize the effects of variations in structural load path, and be adapted to any structural geometry or mechanical requirement. The Resonance Sensor is particularly suited to this purpose as the system senses the structure's response to load by looking at changes in the dynamic characteristics of the structural material in the path length of the induced signal.

It is a further objective of the present invention to provide a Resonance Sensor system that affords the option of tailoring the physical size and profile of actuator and receiver elements to the specific requirements of the subject structure. The actuator and receiver elements of the Resonance Sensor can be selected from a very broad range of commercially available options. Very small, very low profile commercially available actuator and sensor elements make Resonance Sensor implementable in critical structural areas while minimizing the potential for structural or mechanical interference, and greatly expanding the scope of potential structural locations for sensor use. Individual actuator and receiver components can be as small or as large as required by the individual application. This is in contrast to the inductance sensors of the prior art, especially the ones specifically adapted to aircraft strain measurements that suffer from limitations on minimum sensor size, and from a large three-dimensional sensor profile.

It is a further objective of the present invention to provide a Resonance Sensor system that, in contrast with certain embedded load cell application of prior art, presents no danger to structural integrity.

It is a further objective of the present invention to provide a Resonance Sensor system that is composed of very lightweight actuation and sensing elements. The sum of Resonance Sensor system components amounts to a very small incremental weight relative to the structures it can be placed on. As opposed to the pressure transducer methodologies of Nance and others, the Resonance Sensor approach requires no pumps or mechanical plumbing.

It is a further objective of the present invention to provide a Resonance Sensor system that is composed of inexpensive components, including the actuation and sensing elements. The actuator and receiver elements of the Resonance Sensor can be selected from a very broad range of commercially available options. The electronics required to control the measurement process and perform the necessary computations, can easily be made from off-the-shelf components for a relatively inexpensive system cost.

### BRIEF DESCRIPTION OF THE FIGURES

The invention will be more fully understood from the following detailed description taken in conjunction with the accompanying drawings in which:

FIG. 1 provides a diagrammatic representation of an exemplary resonance load sensor system of the invention;

FIG. 2 provides a plot of amplitude versus frequency for a resonance load sensor system and method of the invention showing convergence at higher order bending modes;

FIG. 3 illustrates a measurement of changing resonance frequency with varying load according to an embodiment of the invention;

FIG. 4 illustrates a measurement of changing resonance frequency and changing phase angle according to embodiments of the invention;

FIG. 5 further illustrates a measurement of changing phase angle according to an embodiment of the invention;

FIG. 6 shows the system of FIG. 1 applied to a landing gear;

FIG. 7 shows the system of FIG. 1 applied to an air plane;

FIG. 8 shows the system of FIG. 1 applied to a helicopter;

FIG. 9 shows the system of FIG. 1 applied to a ground-based vehicle; and

FIG. 10 shows the system of FIG. 1 applied to a static structure.

### DETAILED DESCRIPTION OF THE INVENTION

The present invention relates to a system for sensing the load in a structure or structural component by exciting higher order bending modes in that structure and measuring shifts in the resonant frequencies and phases of selected higher order modes that are caused by changes in gravitational loading of the structure. This load sensing system is referred to herein as a resonance load sensor. A wave is generated by one or more actuators placed spatially on the structural element in such a way as to optimize the excitation of the intended resonant modes. The resulting wave propagates through the structure and is received by one or more receivers, or sensors, that are positioned spatially on the structural element in such a way so as to minimize unwanted modes and extraneous acoustic noise and increase the receiver's sensitivity for the intended resonant modes. Changes in loading cause both the frequency and the phase of the excited resonant modes to shift. The present invention measures these frequency and phase shift changes, and by employing the proper data acquisition, data processing, computer memory and storage, associated electrical power, amplification and filtration subsystems, precisely measures the axial load on the instrumented structural element.

When a complex structure, e.g. an aircraft or ground vehicle structure, is so instrumented, the present invention serves as the primary sensory component for a highly accurate, automatic, on-board vehicular weight and balance system. This sensor system can also be used in non-vehicular structures to measure axial loading, and hence gravitational mass loading, of structural elements and structural systems.

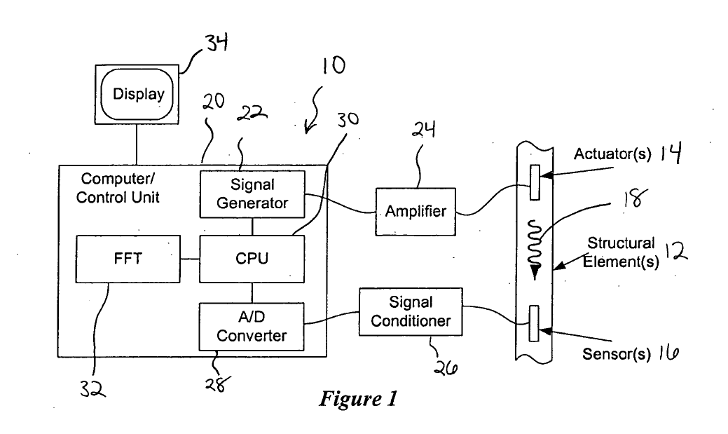

An exemplary system 10 for measuring a load on a structural element 12 is illustrated in FIG. 1. This system shows one actuator 14 and one sensor 16 disposed in an axially displaced configuration on structural element 12. A person of ordinary skill in the art will recognize that other configurations are possible and that a plurality of actuators and/or sensors can be deployed depending upon the type of load measurements that are desired. In a preferred embodiment, actuator 14 is a piezoelectric actuator and sensor 16 is a piezoelectric sensor. The sensor and actuator can be attached to the structural element in any way that allows them to perform their intended function, including by bonding, clamping, or bolting to the structural element. In one embodiment, a piezoelectric actuator 14 or sensor 16 can be created by arranging piezoelectric elements in a stack inside a housing with which the stack is in mechanical contact. The stack can then be bolted to structural element 12 in a way that allows vibrations to created by the actuator to be transferred to the structural element, and vibrations in the structural element to be transferred to the sensor.

The piezo electric actuator 14 and sensor 16 can be constructed using conventional flat or angled piezo transducers that can be mounted in a base for appropriate attachment to structural element 12. In addition, the piezo electric actuator 14 and sensor 16 can be constructed using conformal piezoelectric transducers that are flexible and can be directly fixed to curved or other surfaces of structural element 12. Actuator 14 could also be another type of actuator that will work with the invention such as, for example, MEMS micro-machine actuators, conventional hydro/pneumatic actuators, magneto-restrictive actuators and gas-transfer actuators. MEMS micro-machine actuators can provide an inexpensive, non-intrusive and repeatable local excitation source specifically designed to stimulate resonance response. Gas-transfer actuators are essentially powered by a combustion process initiated from an electrical or optical source and can potentially provide forces greater than those from hydro/pneumatic or magneto-restrictive actuators. Similarly, sensor 16 could be another type of sensor that will work for the intended purpose within a system of the invention such as, for example, a fiber optic or other strain sensor or an accelerometer.

In system 10, a standing wave 18 is generated in structural element 12 by a plurality of actuators 14 disposed on the structural element in such a way as to optimize the excitation of the intended resonant modes. The resulting standing wave 18 is sensed by a plurality of sensors that are attached along the structural element in such a way so as to filter out unwanted modes and minimize unwanted standing wave activity, thus increasing sensitivity to the resonant modes of interest.

The absolute and relative spatial points of attachment of the wave actuators 14 and wave sensors 16 on the surface of the subject structural element 12 is preferably optimized in order to maximize sensitivity to the desired resonant modes and minimize sensitivity to reflected waves or transmitted vibrations from adjacent structures.

In one aspect, in order to minimize sensitivity to wave reflection from the boundaries of the structural element 12, a finite element analysis is performed in order to identify optimal spatial positioning of the wave actuators 14 and wave sensors 16. This is accomplished by modeling wave behavior as it propagates from the actuator through the structural element and interacts or reflects at the boundaries of that particular component or with connecting structural mechanisms. Optimal spatial positioning locates both the wave actuator and wave sensor at points, known as nodes that minimize reflected wave amplitude.

In another aspect, the FE analysis positions both wave actuators 14 and wave sensors 16 on the surface of the structural element 12 in order to maximize sensitivity to the excitation of the intended resonant modes. This is accomplished by positioning wave sensors at a radius of action from the wave actuators that coincides with the anti-nodes, or points of maximum amplitude, of the resonant modes of interest.

In addition to the elements disposed on the structural element 18, system 10 of the invention can include a computer/control unit 20 that can drive the one or more actuators 14 and process signals from the one or more sensors 16. Computer/control unit 20 can be a general purpose computer, such as personal and workstation computers known in the art (as well as other types of general purpose digital computing devices), configured for use with the invention. Or, computer/control unit 20 can be a special purpose digital computing device designed for operation within the scope of the present invention.

In general, computer/control unit 20 includes a signal generator 22 that can be directed to drive one or more actuators 14 at one or more frequencies. An amplifier or amplifiers 24, which can be located on or off of the computer/control unit, process the signals for physical application by the actuators. On the sensor 16 side, a signal conditioner 26 (again, the signal conditioner can be on or off of the computer/control unit) can receive signals from the sensor or sensors 16 and amplify and or filter those signals before passing them along to the computer/control unit 20. On the computer/control unit, an analog to digital converter 28 can receive the signal from the sensor or sensors 16 and process that signal into a digital signal that can further be processed digitally by the computer/control unit 20.

Central processing unit 30 in the computer/control unit is programmed with software to direct signal generator 22 and to process signals from the analog to digital converter 28. A person of ordinary skill in the art will recognize that CPU 30 could be any number of general or special purpose processors available in the art, including vector processors and multiple core or multi-CPU processors. CPU 30 preferably includes a Fast Fourier Transform unit 32 to aid in processing incoming signals from sensor(s) 16, and can be implemented in hardware or in software or firmware on the CPU 30.

The operation or programming of CPU 30 to operate signal generator 22 and to process signals from sensor(s) 16 can best be described by explaining the underlying principles of the invention. The operation of the disclosed embodiments is based on the physical principle that a structural beam or column exhibits certain natural frequencies of vibration and associated modes of deformation, and that changes in the axial loading of the structure cause a measurable shift in both the structure's resonant frequency of vibration and in the associated phase of the each bending mode.

Higher order bending modes are significantly less sensitive to structural boundary conditions than lower order modes. This insensitivity is caused by the behavior of the hyperbolic components of the mode shape equations at high frequencies, and by the fact that the natural frequencies and mode shapes exhibit a convergence trend at very high frequencies. This combination of factors enables the current invention to measure axial loads in components of complex structures, such as aircraft, in the presence of the variable boundary and operating conditions created by external forces.

From the mechanics of materials, the equation for the flexural bending of a slender beam is:

$$- \frac{{\partial }^{2}}{\partial {x}^{2}} [ EI ( x ) \frac{{\partial }^{2}}{\partial {x}^{2}} y ( x , t ) ] + f ( x , t ) = m ( x ) \frac{{\partial }^{2}}{\partial {t}^{2}} y ( x , t ) \qquad eq . 1$$

where y(x, t) is the transverse deformation of the beam, m(x) is mass density, or mass per unit length, E is Young's modulus of elasticity, and I(x) is the cross sectional moment of inertia. To solve this problem analytically, four boundary conditions (two at x=0 and two at x=L where L is the beam length) must be specified. The mathematical expressions for the boundary conditions are shown in equations 2 below:

$$\begin{matrix} Free Boundary & \frac{{\partial }^{2} y ( x , t )}{\partial {x}^{2}} = \frac{{\partial }^{3} y ( x , t )}{\partial {x}^{3}} = 0 \\ Clamped Boundary & y ( x , t ) = \frac{\partial y ( x , t )}{\partial x} = 0 \\ Pinned Boundary & y ( x , t ) = \frac{\partial {y}^{2} ( x , t )}{\partial {x}^{2}} = 0 \\ Sliding Boundary & \frac{\partial y ( x , t )}{\partial x} = \frac{\partial {y}^{3} ( x , t )}{\partial {x}^{3}} = 0\end{matrix} \qquad eqs . 2$$

The mode equation and natural frequency solutions for a single span beam with uniform elasticity and mass density for a variety of illustrative boundary conditions are presented in equations 3, below:

$$eqs . 3 \text{:}$$

$$\begin{matrix}Natural\_Frequency ( hz ) \text{:} & {ω}_{i} = \frac{{λ}_{i}^{2}}{2 π {L}^{2}} {( \frac{EI}{m} )}^{\frac{1}{2}} ; & for & i = 1 , 2 , 3 … & & & \\ Free \text{-} Free \text{:} & λ = ( 2 i + 1 ) \frac{π}{2} & & cosh \frac{{λ}_{i} x}{L} + cos \frac{{λ}_{i} x}{L} - {σ}_{i} ( sinh \frac{{λ}_{i} x}{L} + sin \frac{{λ}_{i} x}{L} ) ; & {σ}_{i} = 1 & for & i > 5 \\ Clamped \text{-} Free \text{:} & λ = ( 2 i - 1 ) \frac{π}{2} & & cosh \frac{{λ}_{i} x}{L} - cos \frac{{λ}_{i} x}{L} - {σ}_{i} ( sinh \frac{{λ}_{i} x}{L} - sin \frac{{λ}_{i} x}{L} ) ; & {σ}_{i} = 1 & for & i > 5 \\ Free \text{-} Pinned \text{:} & λ = ( 4 i + 1 ) \frac{π}{4} & & cosh \frac{{λ}_{i} x}{L} + cos \frac{{λ}_{i} x}{L} - {σ}_{i} ( sinh \frac{{λ}_{i} x}{L} + sin \frac{{λ}_{i} x}{L} ) ; & {σ}_{i} = 1 & for & i > 5 \\ Clamped \text{-} Pinned & λ = ( 4 i + 1 ) \frac{π}{4} & & cosh \frac{{λ}_{i} x}{L} - cos \frac{{λ}_{i} x}{L} - {σ}_{i} ( sinh \frac{{λ}_{i} x}{L} - sin \frac{{λ}_{i} x}{L} ) ; & {σ}_{i} = 1 & for & i > 5 \\ Clamped \text{-} Clamped & λ = ( 2 i + 1 ) \frac{π}{2} & & cosh \frac{{λ}_{i} x}{L} - cos \frac{{λ}_{i} x}{L} - {σ}_{i} ( sinh \frac{{λ}_{i} x}{L} - sin \frac{{λ}_{i} x}{L} ) ; & {σ}_{i} = 1 & for & i > 5 \\ Clamped \text{-} Sliding & λ = ( 4 i - 1 ) \frac{π}{4} & & cosh \frac{{λ}_{i} x}{L} - cos \frac{{λ}_{i} x}{L} - {σ}_{i} ( sinh \frac{{λ}_{i} x}{L} - sin \frac{{λ}_{i} x}{L} ) ; & {σ}_{i} = 1 & for & i > 5\end{matrix}$$

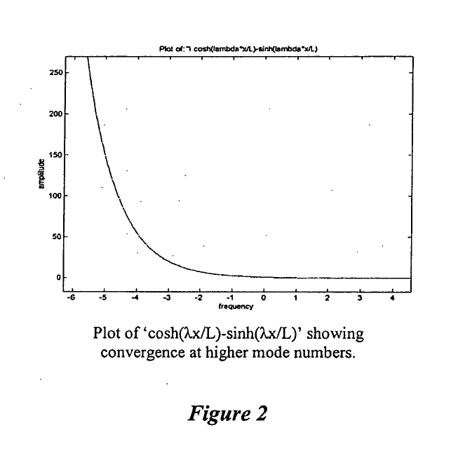

The hyperbolic terms in the mode shapes equations trend toward unity at higher frequencies, as can be seen in FIG. 2 which provides a plot of ‘cos h(λx/L)−sin h(λx/L)’ and shows convergence at higher mode numbers.

The utility in these results is that a method for measuring axial loading using measurements of natural frequency and phase shifting is insensitive to changing structural boundary conditions when employing higher order bending modes. The method is therefore applicable to complex structures that experience variable and unknown, or at least unmeasured, external force applications.

Identifying the exact modes that are to be excited requires a case-by-case structural analysis (numerical analysis and/or physical experiment) of each structure that is to be instrumented. The selection of higher order bending modes is preferred in order to minimize the effects of structural boundary conditions. In one embodiment, the bending mode selected is second order or higher.

In one embodiment, a Finite Element Model of the subject structural component is created that models the dimensions, material characteristics and physical parameters of the subject structure. A computer analysis (such as a Finite Element Analysis (FEA)) of the subject structural component is then conducted in order to examine the subject structure's dynamical behavior and to identify the appropriate higher-order resonant modes for that particular structural component.

In another embodiment, the resonant modes can be identified experimentally through a variety of methods. One method involves systematically exciting the structure across a wide range of frequencies and examining the response of the sensors as a function of the signal driving the actuators, i.e. examining the transfer function of the sensor response to the excitation drive signal. The peaks of the transfer function represent the resonant frequencies. Having identified the resonant frequencies of interest, the actuator will perform a sine sweep through a band of frequencies slightly above and below each resonant frequency of interest. By monitoring the exact frequency, and phase, that each resonance occurs at while the axial load changes allows for a direct measurement of the axial loading. A random signal can also be used instead of a sine sweep.

In one aspect, in order to minimize sensitivity to wave reflection from the boundaries of the structural element, a finite element analysis is performed in order to identify optimal spatial positioning of the wave actuators and wave sensors. This is accomplished by modeling wave behavior as it propagates from the actuator through the structural component and interacts or reflects at the boundaries of that particular component or with connecting structural mechanisms. Optimal spatial positioning locates both the wave actuator and wave sensor at points, known as nodes that minimize reflected wave amplitude.

In another embodiment, the FE analysis positions both wave actuators and wave sensors on the surface of the structural component in order to maximize sensitivity to the excitation of the intended resonant modes. This is accomplished by positioning wave sensors at a radius of action from the wave actuators that coincides with the anti-nodes, or points of maximum amplitude, of the resonant modes of interest.

After proper structural analysis and implementation of wave actuators and sensors, a calibration is performed to determine the relationship between changes in load and changes in structural resonant frequency response, such that a given set of resonant frequencies corresponds to the magnitude of the axial loading. When calibrated, the present invention determines axial compressive or tensile loading in a subject structural component by exciting resonant modes in the subject component, and measuring changes in both the frequency and the phase of those resonant modes as the subject's tensile or compressive load changes.

When a plurality of a vehicle's or static structure's structural components are instrumented in this way, it is possible through a general structural calibration (see U.S. Pat. No. 6,415,242 to Weldon et al. and entitled “System for weighing fixed wing and rotary wing aircraft by the measurement of cross-axis forces,” which patent is hereby incorporated by reference) to deduce the both magnitude and distribution of the overall load on a structure, thereby creating an automatic, on-board weight and balance system.

One embodiment of a method of the invention can now be described by referring to the operation of the elements of the resonance load sensor system 10 of FIG. 1. The system computer/control unit 20 controls the actuator or actuators 14 to perform a frequency sweep procedure whereby the actuators excite a narrow band of frequencies around a known resonant frequency. The receiving sensor or sensors 16 then observe the structural response to excitation in the band range of excitation.

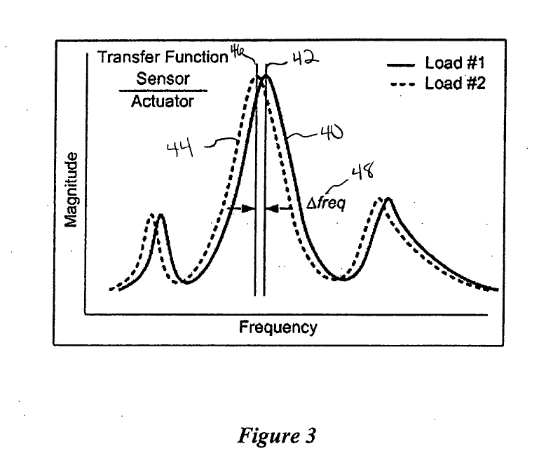

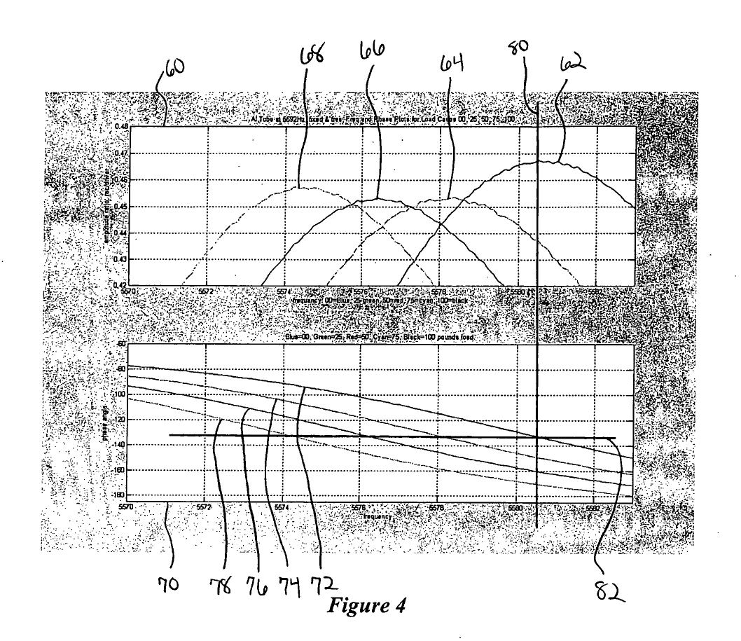

The system computer/control unit 20 employs its FFT unit 32 to perform a Fast Fourier Transform on the ratio of the sensor signal to the actuator signal for each sensor/actuator pair desired, converting the data from time domain to frequency domain. The computer/control unit then identifies the exact resonant frequency in any particular band by identifying the peak ratio in the transfer function as shown, for example, in FIG. 3. In FIG. 3, a magnitude/frequency plot for a first load 40 is illustrated, with a resonance apparent at the first load resonance frequency 42. This process can be performed for a plurality of sensor/actuator pairs, and for a plurality of bending modes (and associated resonant frequencies).

Using data from a calibration procedure as described above, the system computer/control unit 20 analyzes changes in resonance frequencies and determines the structural load changes that would generate such a resonant frequency change. The calibration procedure can be based on the results of a single resonant mode and associated frequency change, or on a plurality of such mode and frequency changes. For example, in FIG. 3, a magnitude/frequency plot for a second load 44 is illustrated, with a resonance apparent at the second load resonance frequency 46. By comparing the change in frequency 48 from the first load 40 to the second load 44, changes in the loading from the first to the second can be calculated.

Operationally, this procedure can be performed continuously or periodically, with axial-load data updated with a response time that depends on a number of parameters, such as the frequency sweep bandwidth, the number of frequencies that are to be swept, the number of sensor/actuator pairs, and the processing speed of the data acquisition system.

In one embodiment, the present invention measures loads by measuring changes in phase angle in resonant modes caused by changes in axial loading through the use of a Phase Locked Loop (PLL), phase comparator or other phase measurement device operating at or near a resonance in a higher bending mode. This embodiment can be illustrated using the plots provided in FIG. 4. A first plot 60 shows an amplitude ratio plotted against frequency for five different loading conditions on an aluminum tube: unloaded or 0 pounds 62; 25 pound axial load 64; 50 pound axial load 66; and 75 pound axial load 68. The resonance frequency (apparent in plot 60 by the peak amplitude ratio for each loading) in the unloaded case is approximately 5580.5 Hz as shown by vertical line 80. As can be seen in the Figure, as the axial loading is increased, the resonance frequency drops. In addition, however, plot 70 (the second of the two plots in FIG. 4) indicates that for these same loadings (unloaded or 0 pounds 72; 25 pound axial load 74; 50 pound axial load 76; and 75 pound axial load 78), the phase angle at a given frequency (the 5580.5 unloaded resonance frequency, for example) shifts in a way that is proportional to axial loading.

In operation, system 10 of FIG. 1 can be employed in this embodiment of the invention to measure changes in loading by measuring changes in the associated phase angle for a constant frequency as follows: One or more resonance modes of interest are selected, and a plurality of modes might be selected in order to achieve better system accuracy, and achieve improved system robustness through increased system redundancy. The system can be calibrated by applying actuator(s) 14 and sensor(s) 16 to measure both frequency and phase angle shift at resonance as a function of multiple loading conditions (weight and center of gravity location). Resonant frequency can be determined by applying Narrowband FFT 32 procedures with peak detection and using calibration data to calculate loading in the structure.

The system 10 records shifts in phase angle at given excitation frequencies (the resonant frequency of a selected mode of the unloaded structure) as a function of multiple loading conditions (weight and center of gravity location). This is accomplished by employing a phase lock loop, a phase comparison device, or other phase measurement device to record phase angle shifts at certain resonant frequencies as a function of multiple loading conditions (weight and cg location) in the signal conditioner 26 or onboard the computer/control unit in hardware or software.

The structure can then be excited using actuator(s) 14 at a constant frequency and changes in axial loading can be measured by measuring changes in phase angle at that constant frequency. The system employs a phase lock loop, phase comparator or other phase measurement device to detect these shifts in phase angle at a fixed excitation frequency. Calibration data can be used to calculate axial loading in the structure. More than one resonant mode can be used to increase accuracy.

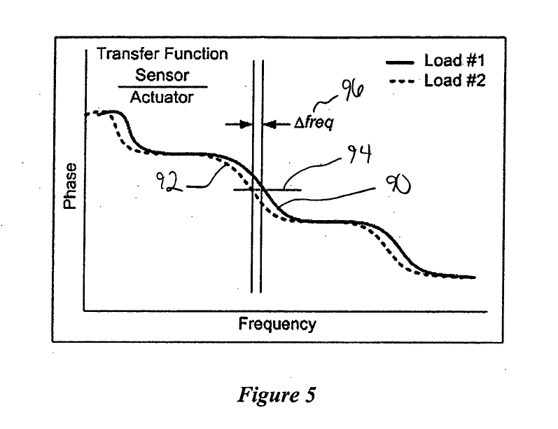

In another embodiment, a constant phase analysis can be used to determine resonant frequency. This embodiment can be illustrated by reference to the plot in FIG. 5. In this plot, which shows phase angle versus frequency for a first load 90 and a second load 92. A horizontal “constant phase angle” line 94 can be constructed that intersects the phase lines 90, 92 of the different load cases. This line 94 can be drawn by starting at the phase value of the unloaded structure at resonance (as is also illustrated in FIG. 4 as horizontal line 82).

A system 10 (FIG. 1) according to this embodiment of the invention identifies an initial resonant frequency and associated phase angle through the use of calibration data. The computer/control unit 20 then acts to drive the signal generator 22 to maintain that phase angle as load conditions change by controlling actuator(s) 14 input frequency. This is accomplished by employing a phase lock loop device which adjusts input frequency to maintain phase angle. The computer/control unit 20 then uses calibration data and measures frequency states as a function of multiple loading conditions (weight and center of gravity location).

In operation, a system 10 according to this embodiment selects a specific initial resonance frequency, identifies the associated phase angle, and then controls the actuator 14 input frequency in order to maintain phase angle. The system 10 can then measure changes in frequency to calculate changes in axial loading. A plurality of resonance modes might be selected in order to achieve better system accuracy, and achieve improved system robustness through increased system redundancy.

The system 10 can be calibrated by measuring both frequency and phase angle shift at resonance as a function of multiple loading conditions (weight and center of gravity location). Resonant frequency is determined by applying Narrowband FFT 32 procedures with peak detection and using calibration data to calculate loading in the structure.

The system 10 can then record shifts in phase angle at given excitation frequencies (e.g., the resonant frequency of a selected mode of the unloaded structure) as a function of multiple loading conditions (weight and center of gravity location). A specific initial resonant frequency and associated phase angle can be selected for measurement. This can be accomplished by employing a phase lock loop, a phase comparison device, or other phase measurement device to record phase angle shifts at certain resonant frequencies as a function of multiple loading conditions. The system can then uses a Phase Lock Loop to maintain the selected phase angle by controlling the frequency of the actuator 14 input.

As the load changes, the system 10 senses changes in phase angle, and acts to maintain the desired phase angle by adjusting (controlling) the input frequency that is generated by the system actuator. The system monitors the new input frequency that is being used to maintain a constant phase angle, and uses calibration data to calculate the loading in the structure.

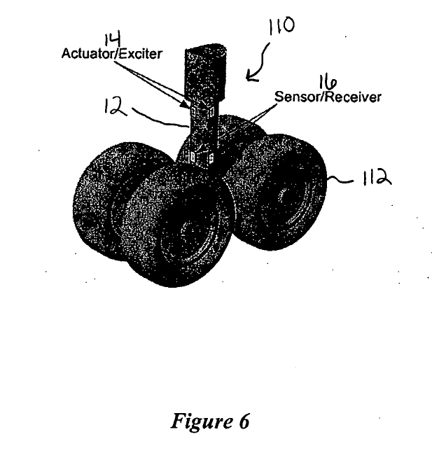

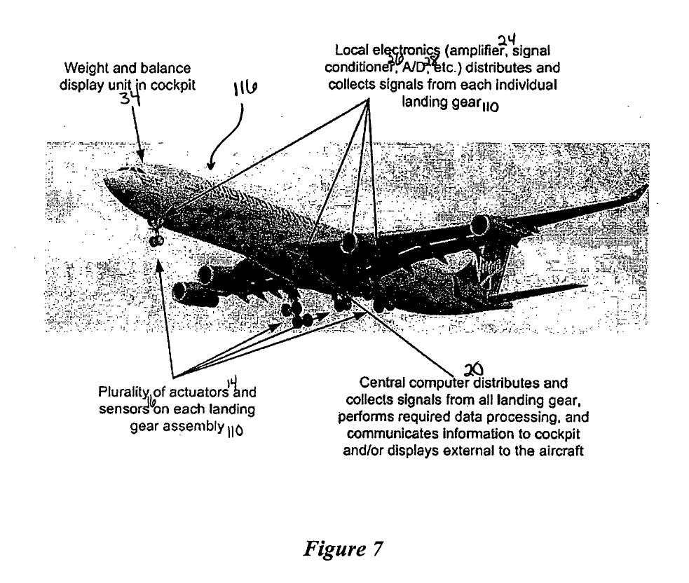

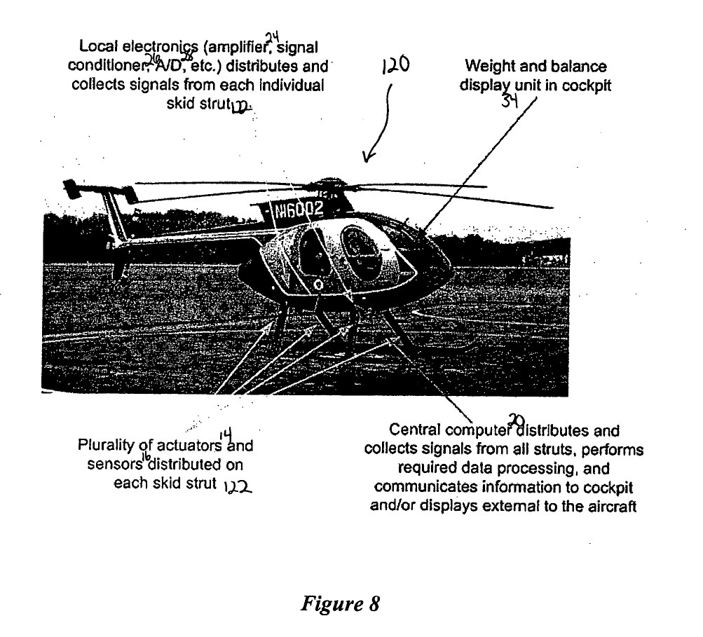

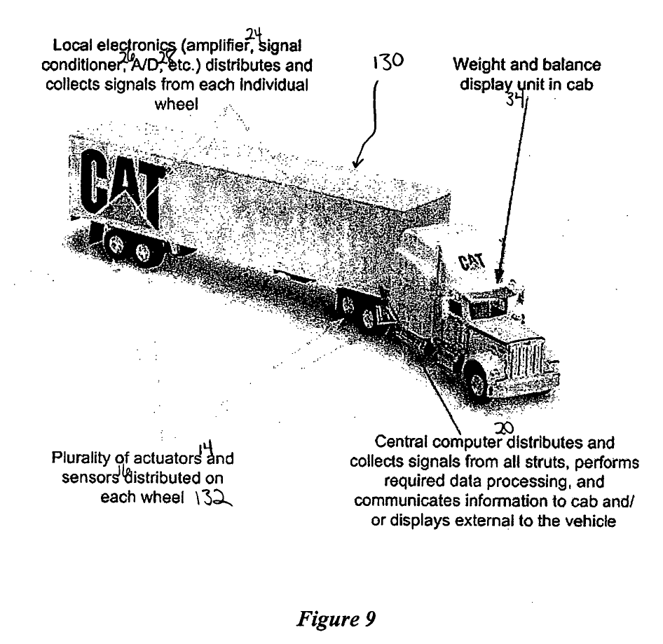

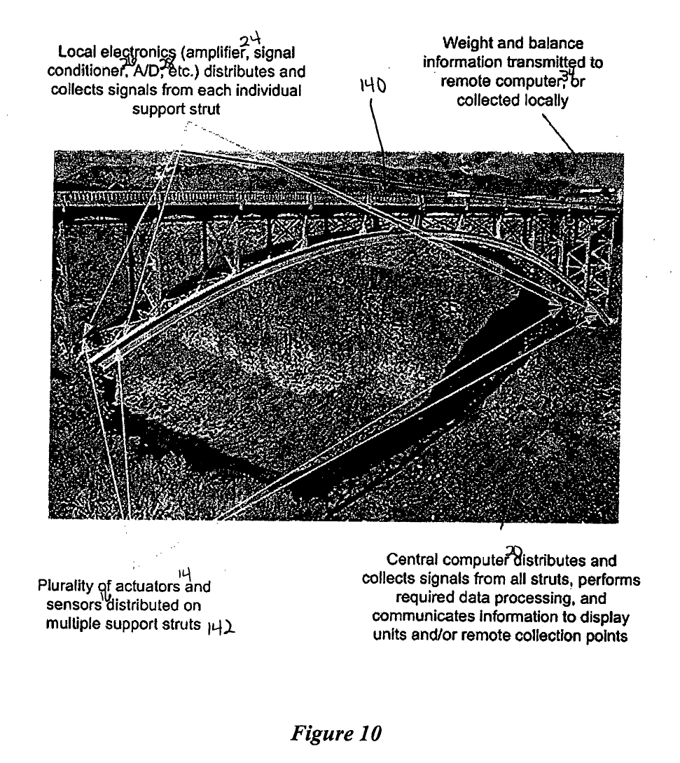

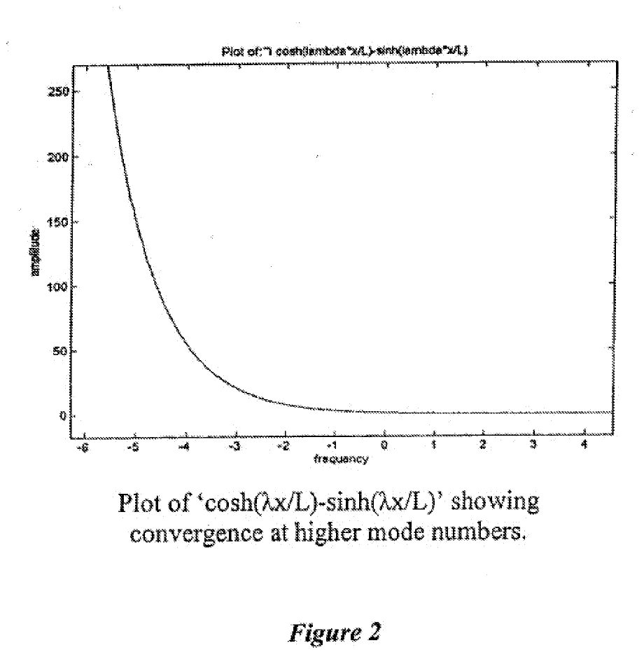

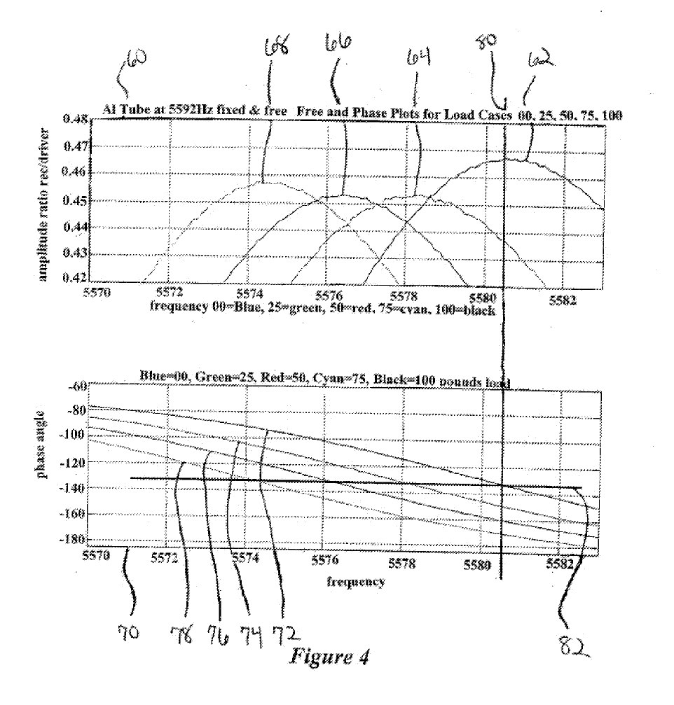

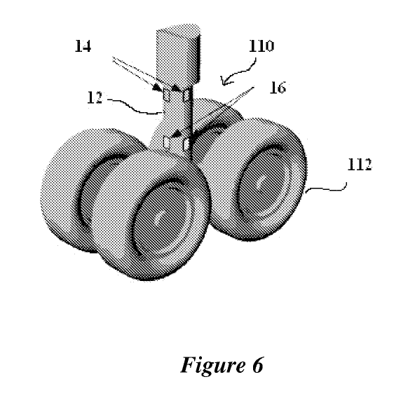

The resonance load sensor system 10 of FIG. 1 can be deployed in certain embodiments for vehicle weight and balance measurement and monitoring. FIG. 6 shows an aircraft landing gear 110 having a ground contacting element 112, in this case wheels, and a structural element 12 extending upward from the ground contacting element. The perspective view of FIG. 6 shows two actuators 14 and two sensors 16 bonded to the structural element, however, a person of ordinary skill in the art will recognize that more or fewer sensors and actuators can be used.

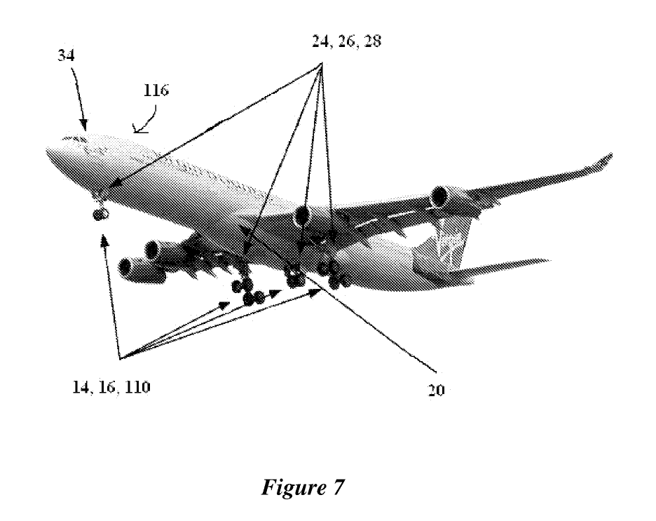

Turning now to FIG. 7, a resonance load sensor system 10 is deployed on an aircraft 116. The aircraft has a plurality of landing gear 110 having a plurality of actuators 14 and sensors 16 disposed on a structural element of each landing gear assembly. Certain electronics, such as signal conditioner 26, A/D Converter 28, Amplifier 24, and perhaps other elements, can be distributed on the aircraft. For example, by placing a number of A/D Converters 28 locally with respect to the actuators 14 and sensors 16 placed on landing gear elements 110, the central computer/control unit 20 can communicate with the remote (from the computer) electronics digitally over a wired or wireless digital network on the aircraft. A display unit 34 can be located in the cockpit of the aircraft 116 so that cockpit staff can see the results of the weight and balance sensing and calculations.

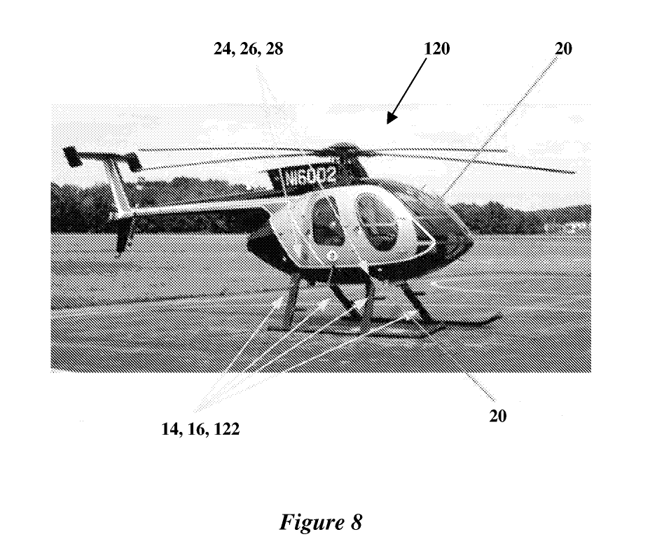

FIG. 8 illustrates a helicopter 120 having a resonance load sensor system 10 applied thereto. The helicopter 120 has a plurality of skid struts 122 having a plurality of actuators 14 and sensors 16 disposed on a structural element of each skid strut assembly. Certain electronics, such as signal conditioner 26, A/D Converter 28, Amplifier 24, and perhaps other elements, can be distributed on the helicopter. A display unit 34 can be located in the cockpit of the helicopter or externally to the helicopter to display the results of the weight and balance sensing and calculations.

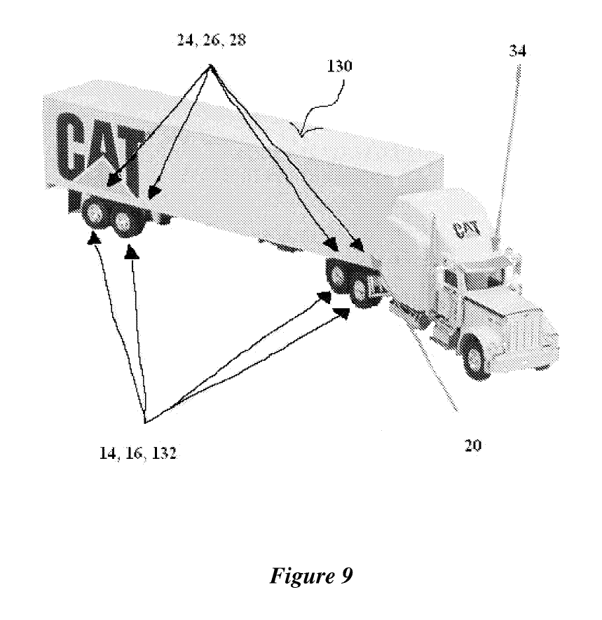

Turning now to FIG. 9, a resonance load sensor system 10 is applied to a truck 130. The truck 130 has a plurality of wheel assemblies 132 having a plurality of actuators 14 and sensors 16 disposed on a structural element of each wheel assembly. Certain electronics, such as signal conditioner 26, A/D Converter 28, Amplifier 24, and perhaps other elements, can be distributed on the truck. A display unit 34 can be located in the cab of the truck or externally to the truck to display the results of the weight and balance sensing and calculations.

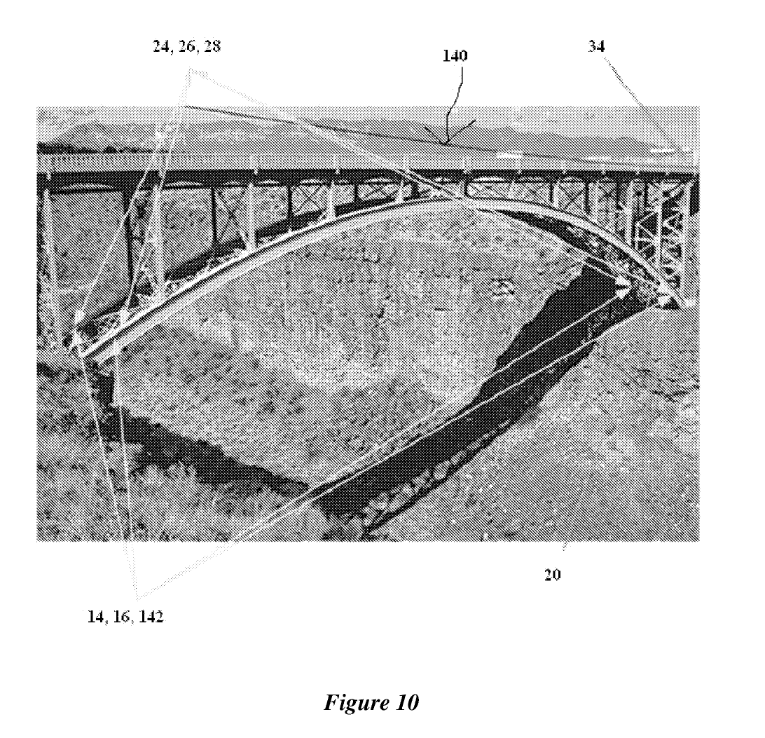

FIG. 10 shows a resonance load sensor system 10 applied to a stationary structure, such as bridge 140. A plurality of actuators 14 and sensors 16 are disposed on support struts 142 on the structure. Certain electronics, such as signal conditioner 26, A/D Converter 28, Amplifier 24, and perhaps other elements, can be distributed on the structure. The results of the sensing and/or weight and balance calculations can be transmitted over a wired or wireless network to a computer (that may be local or remote) for further processing and/or display 34 of the weight and balance results.

A person of ordinary skill in the art will appreciate further features and advantages of the invention based on the above-described embodiments. For example, specific features from any of the embodiments described may be incorporated into systems or methods of the invention in a variety of combinations, as well as features referred to in the claims below which may be implemented by means described herein. Accordingly, the invention is not to be limited by what has been particularly shown and described, except as indicated by the appended claims or those ultimately provided. Any publications and references cited herein are expressly incorporated herein by reference in their entity.

What is claimed is:

1. A method of measuring a load in a structural element comprising:
placing an actuator on the structural element, the actuator being capable of exciting a wave of a predetermined frequency in the structural element;
placing a sensor on the structural element, the sensor being capable of sensing the wave excited in the structural element;
applying a computer control unit to operate the actuator so as to excite a wave in the structural member in at least a first frequency, and to operate the sensor so as to measure at least one of a change in a resonance frequency in the structural element as a result of a change in loading on the structural member and a change in phase angle in the wave sensed by the sensor as a result of a change in loading on the structural member.

2. The method of claim 1, wherein the computer control unit is applied to measure a change in a resonance frequency.

3. The method of claim 2, wherein the resonance frequency corresponds to a higher order bending mode.

4. The method of claim 3, wherein the higher order bending mode is a second order or higher bending mode.

5. The method of claim 2, wherein the computer control unit is applied to measure a change in a resonance frequency at a plurality of bending mode resonance modes.

6. The method of claim 1, wherein the computer control unit is applied to measure a change in a phase angle.

7. The method of claim 6, wherein the computer control unit is applied to measure a change in a phase angle at a desired frequency.

8. The method of claim 7, wherein the desired frequency corresponds to a higher order bending mode resonance frequency for the structural member in an unloaded state.

9. The method of claim 7, wherein a change in phase angle is measured using a phase lock loop, near a resonance of a higher order bending mode.

10. The method of claim 1, where a plurality of sensors are spatially placed on the structural element to filter out undesired modes and thereby increase the sensitivity of the sensing in a desired frequency range.

11. The method of claim 1, wherein the sensor is a piezoelectric sensor.

12. The method of claim 1, wherein the sensor is a strain sensor.

13. The method of claim 1, wherein the sensor is a fiber-optic strain sensor.

14. The method of claim 1, wherein a plurality of actuators are attached to the structural element in a spatial arrangement that optimizes the excitation of the resonant mode of which the change in frequency is tracked to determine the axial load in the structural element.

15. The method of claim 1, wherein the actuator is a piezoelectric actuator.

16. The method of claim 1, wherein the actuator is a magnetostrictive actuator.

17. The method of claim 1, wherein the actuator and sensor are disposed on at least one structural element of a vehicle, and the computer control unit is further programmed to calculate a load applied to the vehicle.

18. The method of claim 17, wherein the calculation of a load applied to the vehicle includes comparing measurements from the vehicle while loaded with calibration data for the vehicle under unloaded and known load situations.

19. The method of claim 18, wherein the calibration is a cross axis calibration.

20. The method of claim 17, wherein the vehicle is selected from the group consisting of an airplane, a helicopter, and a motorized ground vehicle.

21. The method of claim 1, wherein the actuator and sensor are disposed on at least one structural element of a stationary structure.

22. A resonance load sensor system for determining a load on a structural element comprising:
an actuator disposed on the structural element at a first position, the actuator being capable of exciting a wave of a predetermined frequency in the structural element;
a sensor disposed on the structural element at a second position, the sensor being capable of sensing the wave excited in the structural element;
a computer control unit programmed to operate the actuator so as to excite a wave in the structural member in at least a first frequency, and to operate the sensor so as to measure at least one of a change in a resonance frequency in the structural element as a result of a change in loading on the structural member and a change in phase angle in the wave sensed by the sensor as a result of a change in loading on the structural member.

23. The system of claim 22, wherein the computer control unit is programmed to measure a change in a resonance frequency.

24. The system of claim 23, wherein the resonance frequency corresponds to a higher order bending mode.

25. The system of claim 24, wherein the higher order bending mode is a second order or higher bending mode.

26. The system of claim 23, wherein the computer control unit is programmed to measure a change in a resonance frequency at a plurality of bending mode resonance modes.

27. The system of claim 22, wherein the computer control unit is programmed to measure a change in a phase angle.

28. The system of claim 27, wherein the computer control unit is programmed to measure a change in a phase angle at a desired frequency.

29. The system of claim 28, wherein the desired frequency corresponds to a higher order bending mode resonance frequency for the structural member in an unloaded state.

30. The system of claim 28, further comprising a phase lock loop to measure a change in phase angle near a resonance of a higher order bending mode.

31. The system of claim 22, wherein the sensor is a piezoelectric sensor.

32. The system of claim 22, wherein the sensor is a strain sensor.

33. The system of claim 22, wherein the sensor is a fiber-optic strain sensor.

34. The system of claim 22, wherein the actuator is a piezoelectric actuator.

35. The system of claim 22, wherein the actuator is a magnetostrictive actuator.

36. The system of claim 22, wherein the actuator is a piezoelectric actuator stack that is bolted to the structural element so that vibrations created by the piezoelectric actuator stack are transferred through one or more bolts to the structural element.

37. A resonance sensor for measuring load in a structural member through the measurement of the shift in resonant frequency of higher order bending modes, comprising:
an piezoelectric actuator element coupled to the structural member;
a piezoelectric receiver element coupled to the structural member, the actuator and receive combining to create a signal indicating changes in phase and/or in frequency of structural resonant modes; and
a processor for calculating axial load based on the changes in at least one of phase and frequency.
